(19) United States
(12) Patent Application Publication
(10) Pub. No.: US 2024/0054731 A1
(43) Pub. Date: Feb. 15, 2024

(54) PHOTOGRAMMETRY SYSTEM FOR GENERATING STREET EDGES IN TWO-DIMENSIONAL MAPS

(71) Applicant: FARO Technologies, Inc., Lake Mary, FL (US)

(72) Inventors: Matthias Wolke, Korntal-Münchingen (DE); Tharesh Sharma, Waiblingen (DE)

(21) Appl. No.: 18/359,603

(22) Filed: Jul. 26, 2023

Related U.S. Application Data
(60) Provisional application No. 63/396,727, filed on Aug. 10, 2022.

(51) Int. Cl. G06T 19/00; G06T 7/73; G06T 5/00; G06T 17/05; G06T 7/33

(52) U.S. Cl. CPC G06T 19/00; G06T 7/75; G06T 5/002; G06T 17/05; G06T 7/344; G06T 2207/10032; G06T 2207/10028; G06T 2207/20081; G06T 2200/04

(57) ABSTRACT

A computer-implemented method is provided that includes retrieving at least one selected image from a plurality of aerial images of an environment, the at least one selected image comprising surface regions that are concurrently in a three-dimensional (3D) point cloud of the environment. The method further includes detecting areas of the surface regions in the at least one selected image, such that coordinates of the areas of the surface regions are extracted from the at least one selected image. The method further includes comparing the at least one selected image to the 3D point cloud to align common locations in both the at least one selected image and the 3D point cloud. The method further includes displaying an integration of a drawing of the coordinates of the areas of the surface regions in a representation of the 3D point cloud.

### CROSS-REFERENCE TO RELATED APPLICATIONS

This application claims the benefit of U.S. Provisional Patent Application Ser. No. 63/396,727, filed Aug. 10, 2022, and entitled “PHOTOGRAMMETRY SYSTEM FOR GENERATING STREET EDGES IN TWO-DIMENSIONAL MAPS,” the contents of which are incorporated by reference herein in their entirety.

### BACKGROUND

The present invention relates generally to a photogrammetry system for generating street edges in two-dimensional (2D) maps, and more specifically, to automatic 2D sketch generation using photogrammetry.

The points in a three-dimensional (3D) point cloud, such as that generated by a 3D laser scanner time-of-flight (TOF) coordinate measurement device or created by algorithms that takes data from photogrammetry, are very useful. A 3D TOF laser scanner of this type steers a beam of light to a non-cooperative target such as a diffusely scattering surface of an object. A distance meter in the device measures a distance to the object, and angular encoders measure the angles of rotation of two axles in the device. The measured distance and two angles enable a processor in the device to determine the 3D coordinates of the target.

A TOF laser scanner is a scanner in which the distance to a target point is determined based on the speed of light in air between the scanner and a target point. Laser scanners are typically used for scanning closed or open spaces such as interior areas of buildings, industrial installations and tunnels. They may be used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected, stored and sent to a processor or processors to generate a 3D image representing the scanned area or object.

Generating an image requires at least three values for each data point. These three values may include the distance and two angles, or may be transformed values, such as the x, y, z coordinates. In an embodiment, an image is also based on a fourth gray-scale value, which is a value related to irradiance of scattered light returning to the scanner.

Most TOF scanners direct the beam of light within the measurement volume by steering the light with a beam steering mechanism. The beam steering mechanism includes a first motor that steers the beam of light about a first axis by a first angle that is measured by a first angular encoder (or other angle transducer). The beam steering mechanism also includes a second motor that steers the beam of light about a second axis by a second angle that is measured by a second angular encoder (or other angle transducer).

Many contemporary laser scanners include a camera mounted on the laser scanner for gathering camera digital images of the environment and for presenting the camera digital images to an operator of the laser scanner. By viewing the camera images, the operator of the scanner can determine the field of view of the measured volume and adjust settings on the laser scanner to measure over a larger or smaller region of space. In addition, the camera digital images may be transmitted to a processor to add color to the scanner image. To generate a color scanner image, at least three positional coordinates (such as x, y, z) and three color values (such as red, green, blue “RGB”) are collected for each data point.

A 3D point cloud of data points is formed by the set of three positional coordinates (such as x, y, z) and three color values (such as red, green, blue “RGB”). Processing is generally performed on the 3D point cloud of data points which can include millions of data points. However, additional software processing tools for 3D data points in a 3D point cloud can be helpful to a user.

Accordingly, while existing 3D scanners and existing processing for 3D point clouds are suitable for their intended purposes, what is needed is a 3D point cloud processing tool having certain features of embodiments disclosed herein.

### BRIEF DESCRIPTION

According to one embodiment, a computer-implemented method using a photogrammetry system for generating street edges in two-dimensional (2D) maps is provided. The method includes retrieving at least one selected image from a plurality of aerial images of an environment, the at least one selected image comprising surface regions that are concurrently in a three-dimensional (3D) point cloud of the environment. The method includes detecting areas/objects (having edges) of the surface regions in the at least one selected image, such that coordinates of the areas/objects (including the edges) of the surface regions are extracted from the at least one selected images. The method includes comparing the at least one selected image to the 3D point cloud to align common locations in both the selected image and the 3D point cloud, and displaying an integration of a drawing of the coordinates of the edges of the surface regions in a representation of the 3D point cloud.

In addition to one or more features described herein, or as an alternative, further embodiments of the method may include wherein the 3D point cloud is generated from the plurality of aerial images using photogrammetry.

In addition to one or more features described herein, or as an alternative, further embodiments of the method may include wherein the at least one selected image is selected from the plurality of aerial images having been used to generate the 3D point cloud.

In addition to one or more features described herein, or as an alternative, further embodiments of the method may include wherein the areas/objects (including the edges) of the surface regions are detected using machine learning.

In addition to one or more features described herein, or as an alternative, further embodiments of the method may include wherein the plurality of aerial images are orthoimages.

In addition to one or more features described herein, or as an alternative, further embodiments of the method may include wherein the coordinates of the areas/objects (including the edges) of the surface regions are connected by lines to form the drawing of the areas/objects (having the edges), the lines being formed along edges of the surface regions.

In addition to one or more features described herein, or as an alternative, further embodiments of the method may include wherein forward projection is utilized to integrate the drawing into the 3D point cloud.

In addition to one or more features described herein, or as an alternative, further embodiments of the method may include wherein back projection is utilized to integrate 3D data of the 3D point cloud into the at least one selected images.

In addition to one or more features described herein, or as an alternative, further embodiments of the method may include wherein the drawing of the coordinates of the edges of the surface regions is displayed in an orthographic view of the 3D point cloud.

Other embodiments of the present invention implement features of the above-described method in computer systems and computer program products.

According to an embodiment, a system is provided. The system includes a memory having computer readable instructions and one or more processors for executing the computer readable instructions. The computer readable instructions control the one or more processors to perform operations. The operations include retrieving at least one selected image from a plurality of aerial images of an environment, the at least one selected image comprising surface regions that are concurrently in a three-dimensional (3D) point cloud of the environment. The operations further include detecting areas of the surface regions in the at least one selected image, such that coordinates of the areas of the surface regions are extracted from the at least one selected image. The operations further include comparing the at least one selected image to the 3D point cloud to align common locations in both the at least one selected image and the 3D point cloud. The operations further include displaying an integration of a drawing of the coordinates of the areas of the surface regions in a representation of the 3D point cloud.

In addition to one or more features described herein, or as an alternative, further embodiments of the system may include that the 3D point cloud is generated from the plurality of aerial images using photogrammetry.

In addition to one or more features described herein, or as an alternative, further embodiments of the system may include that the at least one selected image is selected from the plurality of aerial images having been used to generate the 3D point cloud.

In addition to one or more features described herein, or as an alternative, further embodiments of the system may include that the areas of the surface regions are detected using machine learning.

In addition to one or more features described herein, or as an alternative, further embodiments of the system may include that the plurality of aerial images are orthoimages.

In addition to one or more features described herein, or as an alternative, further embodiments of the system may include that the coordinates of the areas of the surface regions are connected by lines to form the drawing of the areas, the lines being formed along edges of the surface regions.

In addition to one or more features described herein, or as an alternative, further embodiments of the system may include that forward projection is utilized to integrate the drawing into the 3D point cloud.

In addition to one or more features described herein, or as an alternative, further embodiments of the system may include that back projection is utilized to integrate 3D data of the 3D point cloud into the at least one selected image; and smoothing the at least one selected image by finding 3D points for a line in which the 3D points have a minimal squared sum of a back projection error into a plurality of images.

In addition to one or more features described herein, or as an alternative, further embodiments of the system may include that the drawing of the coordinates of the areas of the surface regions is displayed in an orthographic view of the 3D point cloud.

According to an embodiment, a method is provided. The method includes retrieving at least one selected image from a plurality of aerial images of an environment, the at least one selected image comprising surface regions. The method further includes detecting areas of the surface regions in the at least one selected image, such that coordinates of the areas of the surface regions are extracted from the at least one selected image. The method further includes comparing the at least one selected image to a 3D point cloud to align common locations in both the at least one selected image and the 3D point cloud. The method further includes displaying an integration of a drawing of the coordinates of the areas of the surface regions in a representation of the 3D point cloud.

In addition to one or more features described herein, or as an alternative, further embodiments of the method may include that the 3D point cloud is generated from the plurality of aerial images using photogrammetry.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram of an example drone in accordance with one or more embodiments;

FIG. 2A is a perspective view of a laser scanner in accordance with an embodiment of the invention;

FIG. 2B is a side view of the laser scanner illustrating a method of measurement according to an embodiment;

FIG. 3 is a schematic illustration of the optical, mechanical, and electrical components of the laser scanner according to an embodiment;

FIG. 4 illustrates a schematic illustration of the laser scanner of FIG. 2A according to an embodiment;

FIG. 5 is a block diagram of an example computer system for use in conjunction with one or more embodiments;

FIG. 6 is a block diagram of a computer system for automatic 2D overview sketch generation using photogrammetry according to one or more embodiments;

FIG. 7 depicts a flowchart of a computer-implemented method for processing images according to one or more embodiments;

FIG. 8 depicts a flowchart of a computer-implemented method for generating a sketch of street edges in 2D image(s) and generating the sketch in a 3D image according to one or more embodiments;

FIG. 9 depicts a combination of aerial images of an example environment according to one or more embodiments;

FIG. 10 illustrates example poses for which aerial images were captured according to one or more embodiments;

FIG. 11A depicts a drone image as an example aerial image according to one or more embodiments;

FIG. 11B illustrates a monochromatic predicted image of the drone image in FIG. 11A in which the image has been segmented and coordinates of edges have been captured according to one or more embodiments;

FIG. 12A depicts a drone image as an example aerial image according to one or more embodiments;

FIG. 12B illustrates a predicted image of the drone image in FIG. 12A in which the image has been segmented and coordinates of edges have been captured according to one or more embodiments;

FIG. 13 illustrates a graphical display of an example 2D representation of the 3D point cloud according to one or more embodiments;

FIG. 14 illustrates a graphical display of an example 2D representation of a 3D point cloud with the drawing/sketch of street edges and street markings according to one or more embodiments;

FIG. 15 illustrates a graphical display of the drawing/sketch of street edges and street markings without the 2D representation of the 3D point cloud according to one or more embodiments;

FIG. 16 is a flowchart of a computer-implemented method for generating street edges and markings in 2D maps using photogrammetry according to one or more embodiments;

FIG. 17 illustrates visual display of the automatic 2D sketch generation according to one or more embodiments; and

FIG. 18 depicts drone images and a 3D point cloud generated from the drone images using photogrammetry according to one or more embodiments.

The detailed description explains embodiments of the invention, together with advantages and features, by way of example with reference to the drawings.

### DETAILED DESCRIPTION

The present invention relates to automatic two-dimensional (2D) overview sketch (e.g., a plan view of a scene) generation using photogrammetry which will provide the accurately sketched lines into a three-dimensional (3D) point cloud. Unmanned autonomous vehicles, commonly referred to as “drones,” are quickly becoming essential to public safety professionals who work with crash scene reconstruction. With an inexpensive entrance level in pricing, drones provide fast capture on crash scenes and provide advantages when compared to older methods of data collection. Safety professionals, including the police, need to see street edges marked in the 3D point cloud and/or to filter 3D points lying outside the road edges, as disclosed in one or more embodiments. This can help the police make determinations during a crash scene reconstruction along with providing documentation to support their analysis. Although a safety professional could attempt to make user-drawn edges of the street using a software such a FARO® Zone 3D software, FARO® Zone 2D software, etc., the user drawn edges may not be precise as desired and are time consuming. One or more embodiments are configured to utilize photogrammetry (including image locations and image positions) to automatically generate a 2D sketch overview in the 2D images of photogrammetry and then project the 2D sketch into the 3D point cloud, such that the street edges and/or any other roadway delineations are accurately viewable in the 3D point cloud.

Technical effects and benefits of one or more embodiments include the efficient and automatic reproduction of street edges of streets and roadways for a 3D point cloud generated using 2D images acquired by photogrammetry, thereby saving time and providing a higher level of accuracy over user-drawn lines/edges in a 3D point cloud. Drones, also referred to as unmanned aerial vehicles (UAVs) and remotely piloted aircraft (RPA), have been used to measure two-dimensional coordinates and/or three-dimensional coordinates, and they provide a cost effective way to measure objects or environments without incurring the effort and expense of building structures to support the scanning devices. These systems allow for the rapid acquisition of coordinates in a wide variety of environments.

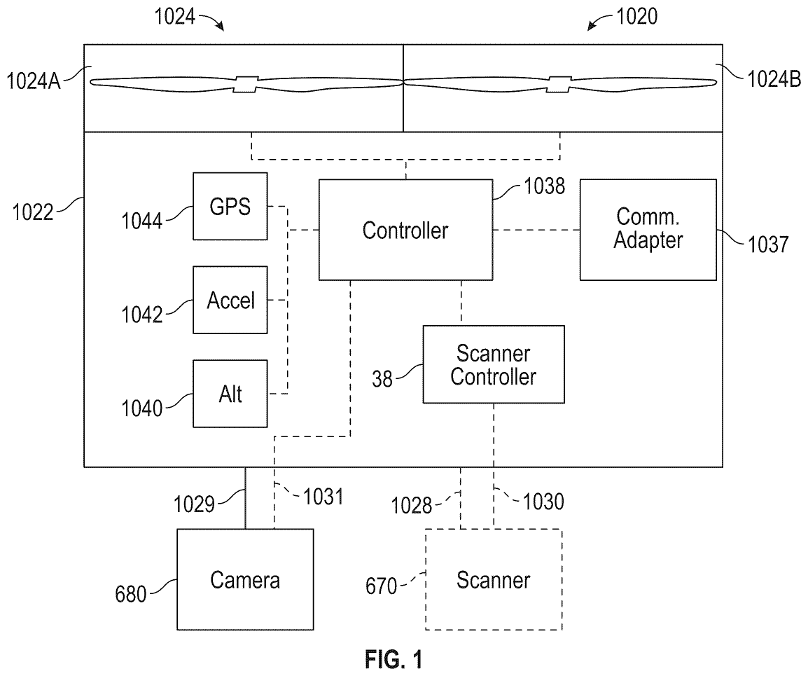

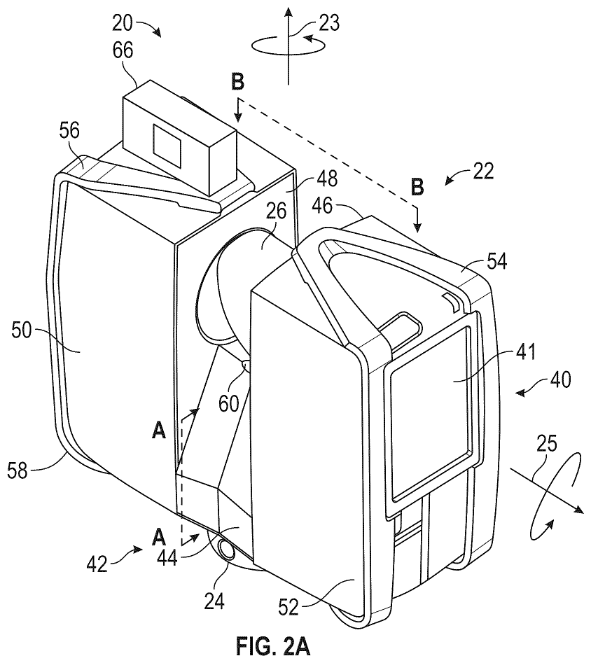

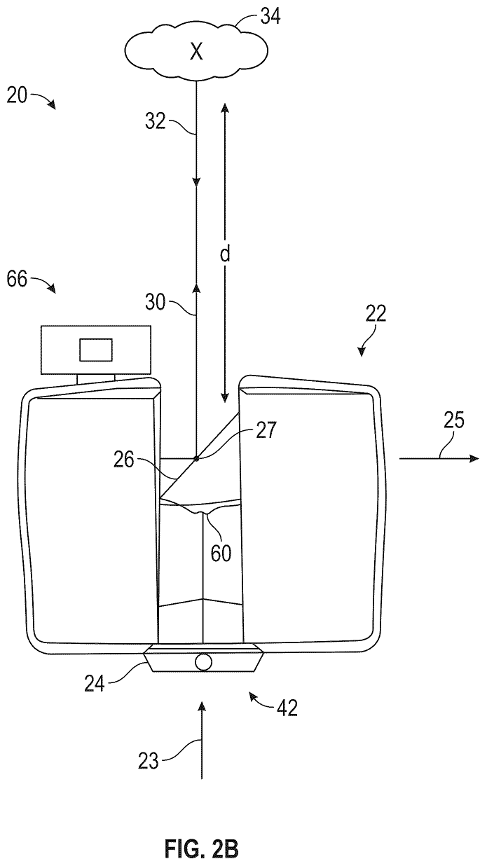

Referring now to FIG. 1, an example drone 1020 is depicted. The drone 1020 can include a scanner 670 such as the laser scanner 20 as discussed in FIGS. 2A, 2B, 3, and 4 and/or another suitable three-dimensional coordinate scanning device. Similarly, the drone 1020 can include a camera 680, for example, having features of the cameras 66, 112 (of laser scanner 20 depicted in FIGS. 2A-4) and/or another suitable camera. The drone 1020 includes a fuselage 1022 that supports at least one thrust device 1024. In an embodiment, the drone 1020 includes a plurality of thrust devices 1024A, 1024B, such as four thrust devices arranged about the periphery of the fuselage 1022. In an embodiment, the thrust devices 1024 include a propeller member that rotates to produce thrust. The thrust devices 1024 may be configurable to provide both lift (vertical thrust) and lateral thrust (horizontal thrust). The vertical and horizontal components of the thrust allow the changing of the altitude, lateral movement, and orientation (attitude) of the drone 1020.

In the exemplary embodiment, the fuselage 1022 and thrust devices 1024 are sized and configured to carry a payload such as an optical scanner 670 that is configured to measure three-dimensional coordinates of points in the environment or on an object. Particularly, the drone 1020 can carry the camera 680 and/or the scanner 670. The scanner 670 may be a time-of-flight scanner, a triangulation scanner, an area scanner, a structured light scanner, or a laser tracker for example. In an embodiment, the scanner 670 may be releasably coupled to the fuselage 1022 by a coupling 1028. The camera 680 may be releasably coupled to the fuselage 1022 by a coupling 1029.

In another embodiment, the scanner 670 may be integral with or fixedly coupled to the fuselage 1022. As will be discussed in more detail herein, the scanner 670 may also be coupled to a scanner controller 38 by a communication and power connection 1030. Similarly, the camera 680 may be coupled to the controller 1038 by a communication and power connection 1031. It should be appreciated that the scanner controller 38 may be located in the scanner 20, within the fuselage 1022, or include multiple processing units that are distributed between the scanner 20, the fuselage 1022, or are remotely located from the drone 1020. The scanner controller 38 may be coupled to communicate with a drone controller 1038.

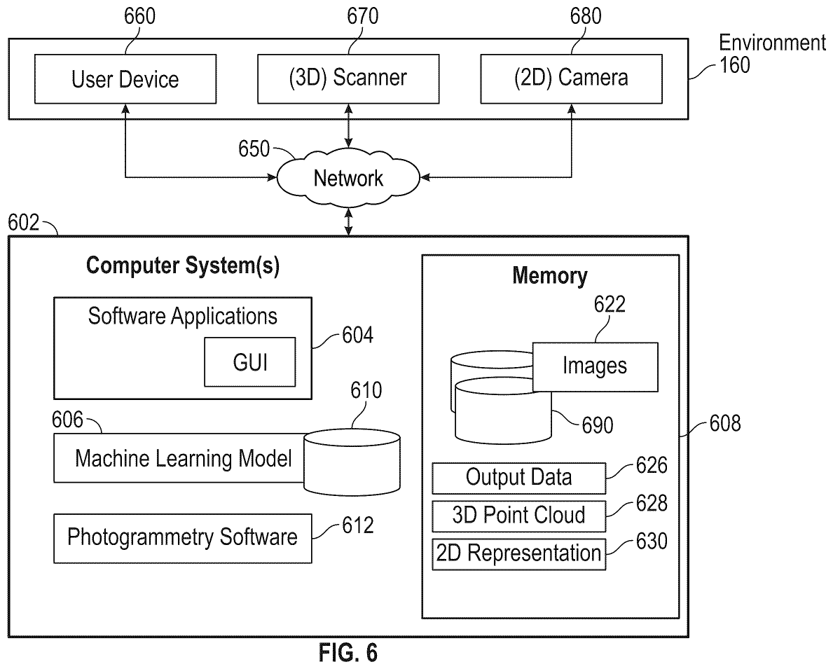

Both the drone controller 1038 and the scanner controller 38 may include processors that are responsive to operation control methods embodied in application code. These methods are embodied in computer instructions written to be executed by the processor, such as in the form of software. The controller 1038 is coupled to the thrust devices 1024 and configured to transmit and receive signals from the thrust devices 1024. The controller 1038 may further be coupled to one or more sensor devices that enable to the controller to determine the position, orientation, and altitude of the drone 1020. In an embodiment, these sensors may include an altimeter 1040, a gyroscope or accelerometers 1042 or a global positioning satellite (GPS) system 1044. In other embodiments, the controller 1038 may be coupled to other sensors, such as force sensors. The drone controller 1038 may be coupled to a communication adapter 1037 to transmit and receive signals from the computer system 602 over the network 650, such that the drone controller 1038 can execute instructions/commands from the computer system 602 as depicted in FIG. 6. Also, the drone controller 1038 can send images to the computer system 602.

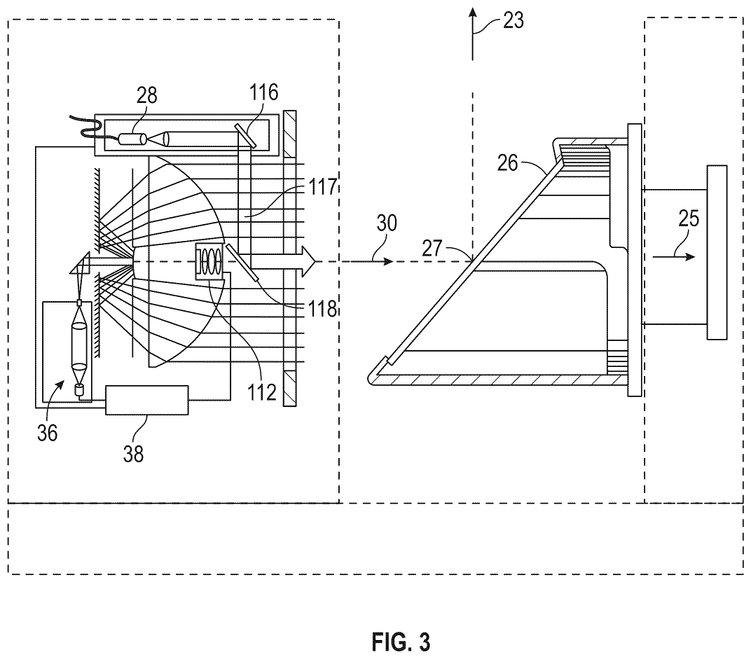

FIGS. 2A, 2B, and 3 depict a coordinate measurement device, such as a laser scanner 20 for optically scanning and measuring the environment surrounding the laser scanner 20. The laser scanner 20 has a measuring head 22 and a base 24. The measuring head 22 is mounted on the base 24 such that the laser scanner 20 may be rotated about a vertical axis 23. In one embodiment, the measuring head 22 includes a gimbal point 27 that is a center of rotation about the vertical axis 23 and a horizontal axis 25. The measuring head 22 has a rotary mirror 26, which may be rotated about the horizontal axis 25. The rotation about the vertical axis may be about the center of the base 24. The terms vertical axis and horizontal axis refer to the scanner in its normal upright position. It is possible to operate a 3D coordinate measurement device on its side or upside down, and so to avoid confusion, the terms azimuth axis and zenith axis may be substituted for the terms vertical axis and horizontal axis, respectively. The term pan axis or standing axis may also be used as an alternative to vertical axis.

The measuring head 22 is further provided with an electromagnetic radiation emitter, such as light emitter 28, for example, that emits an emitted light beam 30. In one embodiment, the emitted light beam 30 is a coherent light beam such as a laser beam. The laser beam may have a wavelength range of approximately 300 to 1600 nanometers, for example 790 nanometers, 905 nanometers, 1550 nm, or less than 400 nanometers. It should be appreciated that other electromagnetic radiation beams having greater or smaller wavelengths may also be used. The emitted light beam 30 is amplitude or intensity modulated, for example, with a sinusoidal waveform or with a rectangular waveform. The emitted light beam 30 is emitted by the light emitter 28 onto a beam steering unit, such as mirror 26, where it is deflected to the environment. A reflected light beam 32 is reflected from the environment by an object 34. The reflected or scattered light is intercepted by the rotary minor 26 and directed into a light receiver 36. The directions of the emitted light beam 30 and the reflected light beam 32 result from the angular positions of the rotary mirror 26 and the measuring head 22 about the axes 25 and 23, respectively. These angular positions in turn depend on the corresponding rotary drives or motors.

Coupled to the light emitter 28 and the light receiver 36 is a controller 38. The controller 38 determines, for a multitude of measuring points X, a corresponding number of distances d between the laser scanner 20 and the points X on object 34. The distance to a particular point X is determined based at least in part on the speed of light in air through which electromagnetic radiation propagates from the device to the object point X. In one embodiment the phase shift of modulation in light emitted by the laser scanner 20 and the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, cₐᵢᵣ=c/n. A laser scanner of the type discussed herein is based on the time-of-flight (TOF) of the light in the air (the round-trip time for the light to travel from the device to the object and back to the device). Examples of TOF scanners include scanners that measure round trip time using the time interval between emitted and returning pulses (pulsed TOF scanners), scanners that modulate light sinusoidally and measure phase shift of the returning light (phase-based scanners), as well as many other types. A method of measuring distance based on the time-of-flight of light depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based on one known length and two known angles of a triangle. The method of triangulation, therefore, does not directly depend on the speed of light in air.

In one mode of operation, the scanning of the volume around the laser scanner 20 takes place by rotating the rotary minor 26 relatively quickly about axis 25 while rotating the measuring head 22 relatively slowly about axis 23, thereby moving the assembly in a spiral pattern. In an exemplary embodiment, the rotary mirror rotates at a maximum speed of 5820 revolutions per minute. For such a scan, the gimbal point 27 defines the origin of the local stationary reference system. The base 24 rests in this local stationary reference system.

In addition to measuring a distance d from the gimbal point 27 to an object point X, the scanner 20 may also collect gray-scale information related to the received optical power (equivalent to the term “brightness.”) The gray-scale value may be determined at least in part, for example, by integration of the bandpass-filtered and amplified signal in the light receiver 36 over a measuring period attributed to the object point X.

The measuring head 22 may include a display device 40 integrated into the laser scanner 20. The display device 40 may include a graphical touch screen 41, as shown in FIG. 2A, which allows the operator to set the parameters or initiate the operation of the laser scanner 20. For example, the screen 41 may have a user interface that allows the operator to provide measurement instructions to the device, and the screen may also display measurement results.

The laser scanner 20 includes a carrying structure 42 that provides a frame for the measuring head 22 and a platform for attaching the components of the laser scanner 20. In one embodiment, the carrying structure 42 is made from a metal such as aluminum. The carrying structure 42 includes a traverse member 44 having a pair of walls 46, 48 on opposing ends. The walls 46, 48 are parallel to each other and extend in a direction opposite the base 24. Shells 50, 52 are coupled to the walls 46, 48 and cover the components of the laser scanner 20. In the exemplary embodiment, the shells 50, 52 are made from a plastic material, such as polycarbonate or polyethylene for example. The shells 50, 52 cooperate with the walls 46, 48 to form a housing for the laser scanner 20.

On an end of the shells 50, 52 opposite the walls 46, 48 a pair of yokes 54, 56 are arranged to partially cover the respective shells 50, 52. In the exemplary embodiment, the yokes 54, 56 are made from a suitably durable material, such as aluminum for example, that assists in protecting the shells 50, 52 during transport and operation. The yokes 54, 56 each includes a first arm portion 58 that is coupled, such as with a fastener for example, to the traverse 44 adjacent the base 24. The arm portion 58 for each yoke 54, 56 extends from the traverse 44 obliquely to an outer corner of the respective shell 50, 52. From the outer corner of the shell, the yokes 54, 56 extend along the side edge of the shell to an opposite outer corner of the shell. Each yoke 54, 56 further includes a second arm portion that extends obliquely to the walls 46, 48. It should be appreciated that the yokes 54, 56 may be coupled to the traverse 42, the walls 46, 48 and the shells 50, 54 at multiple locations.

The pair of yokes 54, 56 cooperate to circumscribe a convex space within which the two shells 50, 52 are arranged. In the exemplary embodiment, the yokes 54, 56 cooperate to cover all of the outer edges of the shells 50, 54, while the top and bottom arm portions project over at least a portion of the top and bottom edges of the shells 50, 52. This provides advantages in protecting the shells 50, 52 and the measuring head 22 from damage during transportation and operation. In other embodiments, the yokes 54, 56 may include additional features, such as handles to facilitate the carrying of the laser scanner 20 or attachment points for accessories for example.

On top of the traverse 44, a prism 60 is provided. The prism extends parallel to the walls 46, 48. In the exemplary embodiment, the prism 60 is integrally formed as part of the carrying structure 42. In other embodiments, the prism 60 is a separate component that is coupled to the traverse 44. When the mirror 26 rotates, during each rotation the mirror 26 directs the emitted light beam 30 onto the traverse 44 and the prism 60. Due to non-linearities in the electronic components, for example in the light receiver 36, the measured distances d may depend on signal strength, which may be measured in optical power entering the scanner or optical power entering optical detectors within the light receiver 36, for example. In an embodiment, a distance correction is stored in the scanner as a function (possibly a nonlinear function) of distance to a measured point and optical power (generally unscaled quantity of light power sometimes referred to as “brightness”) returned from the measured point and sent to an optical detector in the light receiver 36. Since the prism 60 is at a known distance from the gimbal point 27, the measured optical power level of light reflected by the prism 60 may be used to correct distance measurements for other measured points, thereby allowing for compensation to correct for the effects of environmental variables such as temperature. In the exemplary embodiment, the resulting correction of distance is performed by the controller 38.

In an embodiment, the base 24 is coupled to a swivel assembly (not shown) such as that described in commonly owned U.S. Pat. No. 8,705,012 ('012), which is incorporated by reference herein. The swivel assembly is housed within the carrying structure 42 and includes a motor 138 that is configured to rotate the measuring head 22 about the axis 23. In an embodiment, the angular/rotational position of the measuring head 22 about the axis 23 is measured by angular encoder 134.

An auxiliary image acquisition device 66 may be a device that captures and measures a parameter associated with the scanned area or the scanned object and provides a signal representing the measured quantities over an image acquisition area. The auxiliary image acquisition device 66 may be, but is not limited to, a pyrometer, a thermal imager, an ionizing radiation detector, or a millimeter-wave detector. In an embodiment, the auxiliary image acquisition device 66 is a color camera.

In an embodiment, a central color camera (first image acquisition device) 112 is located internally to the scanner and may have the same optical axis as the 3D scanner device. In this embodiment, the first image acquisition device 112 is integrated into the measuring head 22 and arranged to acquire images along the same optical pathway as emitted light beam 30 and reflected light beam 32. In this embodiment, the light from the light emitter 28 reflects off a fixed minor 116 and travels to dichroic beam-splitter 118 that reflects the light 117 from the light emitter 28 onto the rotary minor 26. In an embodiment, the mirror 26 is rotated by a motor 136 and the angular/rotational position of the mirror is measured by angular encoder 134. The dichroic beam-splitter 118 allows light to pass through at wavelengths different than the wavelength of light 117. For example, the light emitter 28 may be a near infrared laser light (for example, light at wavelengths of 780 nm or 1150 nm), with the dichroic beam-splitter 118 configured to reflect the infrared laser light while allowing visible light (e.g., wavelengths of 400 to 700 nm) to transmit through. In other embodiments, the determination of whether the light passes through the beam-splitter 118 or is reflected depends on the polarization of the light. The digital camera 112 obtains 2D images of the scanned area to capture color data to add to the scanned image. In the case of a built-in color camera having an optical axis coincident with that of the 3D scanning device, the direction of the camera view may be easily obtained by simply adjusting the steering mechanisms of the scanner—for example, by adjusting the azimuth angle about the axis 23 and by steering the minor 26 about the axis 25.

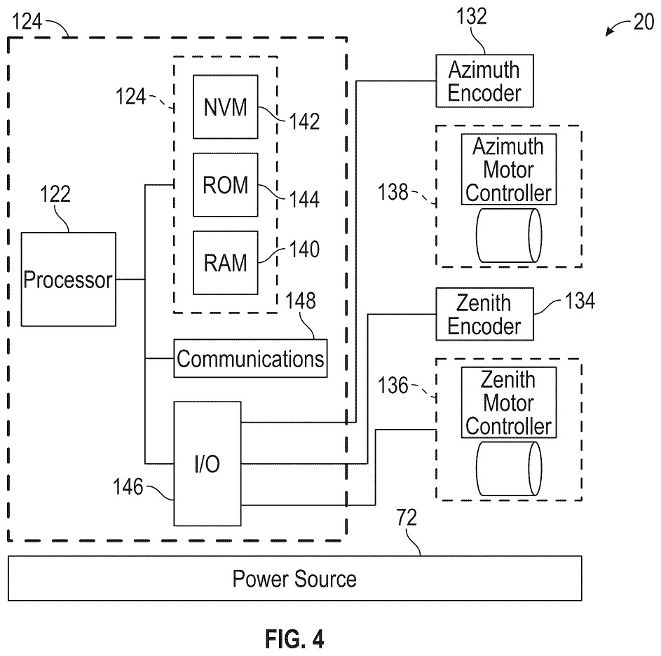

Referring now to FIG. 4 with continuing reference to FIGS. 2A-3, elements are shown of the laser scanner 20. Controller 38 is a suitable electronic device capable of accepting data and instructions, executing the instructions to process the data, and presenting the results. The controller 38 includes one or more processing elements 122. The processors may be microprocessors, field programmable gate arrays (FPGAs), digital signal processors (DSPs), and generally any device capable of performing computing functions. The one or more processors 122 have access to memory 124 for storing information.

Controller 38 is capable of converting the analog voltage or current level provided by light receiver 36 into a digital signal to determine a distance from the laser scanner 20 to an object in the environment. Controller 38 uses the digital signals that act as input to various processes for controlling the laser scanner 20. The digital signals represent one or more laser scanner 20 data including but not limited to distance to an object, images of the environment, images acquired by panoramic camera 126, angular/rotational measurements by a first or azimuth encoder 132, and angular/rotational measurements by a second axis or zenith encoder 134.

In general, controller 38 accepts data from encoders 132, 134, light receiver 36, light source 28, and panoramic camera 126 and is given certain instructions for the purpose of generating a 3D point cloud of a scanned environment. Controller 38 provides operating signals to the light source 28, light receiver 36, panoramic camera 126, zenith motor 136 and azimuth motor 138. The controller 38 compares the operational parameters to predetermined variances and if the predetermined variance is exceeded, generates a signal that alerts an operator to a condition. The data received by the controller 38 may be displayed on a user interface 40 coupled to controller 38. The user interface 40 may be one or more LEDs (light-emitting diodes), an LCD (liquid-crystal diode) display, a CRT (cathode ray tube) display, a touch-screen display or the like. A keypad may also be coupled to the user interface for providing data input to controller 38. In one embodiment, the user interface is arranged or executed on a mobile computing device that is coupled for communication, such as via a wired or wireless communications medium (e.g., Ethernet, serial, USB, Bluetooth™ or WiFi) for example, to the laser scanner 20.

The controller 38 may also be coupled to external computer networks such as a local area network (LAN) and the Internet. A LAN interconnects one or more remote computers, which are configured to communicate with controller 38 using a well-known computer communications protocol such as TCP/IP (Transmission Control Protocol/Internet(\hat{ }) Protocol), RS-232, ModBus, and the like. Additional systems may also be connected to LAN with the controllers 38 in each of these systems being configured to send and receive data to and from remote computers and other systems. The LAN may be connected to the Internet. This connection allows controller 38 to communicate with one or more remote computers connected to the Internet.

The processors 122 are coupled to memory 124. The memory 124 may include random access memory (RAM) device 140, a non-volatile memory (NVM) device 142, and a read-only memory (ROM) device 144. In addition, the processors 122 may be connected to one or more input/output (I/O) controllers 146 and a communications circuit 148. In an embodiment, the communications circuit 148 provides an interface that allows wireless or wired communication with one or more external devices or networks, such as the LAN discussed above.

Controller 38 includes operation control methods embodied in application code. These methods are embodied in computer instructions written to be executed by processors 122, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, C #, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing.

It should be appreciated that while some embodiments herein describe a point cloud that is generated by a TOF scanner, this is for example purposes and the claims should not be so limited. In other embodiments, the point cloud may be generated or created using other types of scanners, such as but not limited to triangulation scanners, area scanners, structured-light scanners, laser line scanners, flying dot scanners, and photogrammetry devices for example.

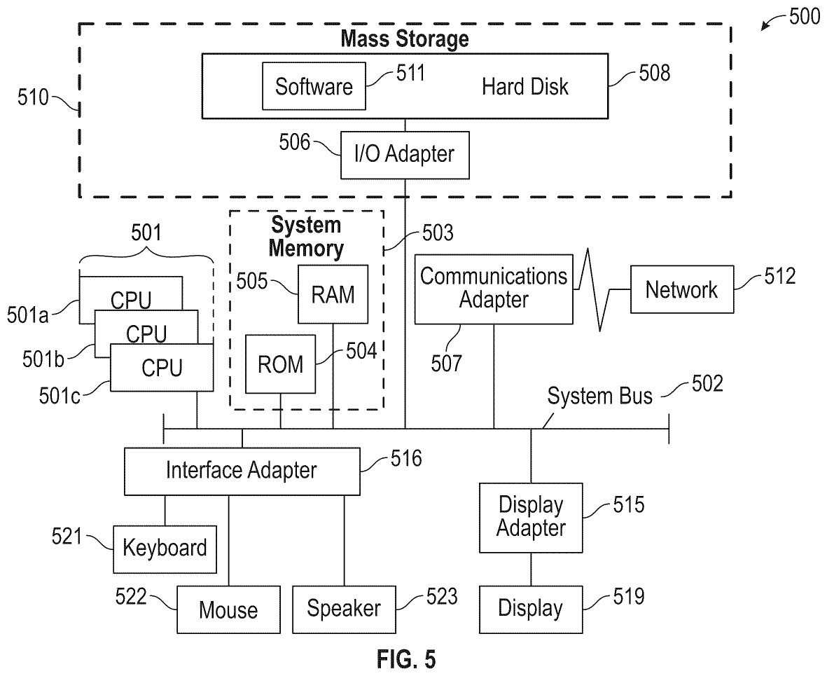

Turning now to FIG. 5, a computer system 500 is generally shown in accordance with one or more embodiments of the invention. The computer system 500 can be an electronic, computer framework comprising and/or employing any number and combination of computing devices and networks utilizing various communication technologies, as described herein. The computer system 500 can be easily scalable, extensible, and modular, with the ability to change to different services or reconfigure some features independently of others. The computer system 500 can be, for example, a server, desktop computer, laptop computer, tablet computer, or smartphone. In some examples, computer system 500 can be a cloud computing node. Computer system 500 can be described in the general context of computer system executable instructions, such as program modules, being executed by a computer system. Generally, program modules can include routines, programs, objects, components, logic, data structures, and so on that perform particular tasks or implement particular abstract data types. Computer system 500 can be practiced in distributed cloud computing environments where tasks are performed by remote processing devices that are linked through a communications network. In a distributed cloud computing environment, program modules can be located in both local and remote computer system storage media including memory storage devices.

As shown in FIG. 5, the computer system 500 has one or more central processing units (CPU(s)) 501a, 501b, 501c, etc., (collectively or generically referred to as processor(s) 501). The processors 501 can be a single-core processor, multi-core processor, computing cluster, or any number of other configurations. The processors 501, also referred to as processing circuits, are coupled via a system bus 502 to a system memory 503 and various other components. The system memory 503 can include a read only memory (ROM) 504 and a random access memory (RAM) 505. The ROM 504 is coupled to the system bus 502 and can include a basic input/output system (BIOS) or its successors like Unified Extensible Firmware Interface (UEFI), which controls certain basic functions of the computer system 500. The RAM is read-write memory coupled to the system bus 502 for use by the processors 501. The system memory 503 provides temporary memory space for operations of said instructions during operation. The system memory 503 can include random access memory (RAM), read only memory, flash memory, or any other suitable memory systems.

The computer system 500 comprises an input/output (I/O) adapter 506 and a communications adapter 507 coupled to the system bus 502. The I/O adapter 506 can be a small computer system interface (SCSI) adapter that communicates with a hard disk 508 and/or any other similar component. The I/O adapter 506 and the hard disk 508 are collectively referred to herein as a mass storage 510.

Software 511 for execution on the computer system 500 can be stored in the mass storage 510. The mass storage 510 is an example of a tangible storage medium readable by the processors 501, where the software 511 is stored as instructions for execution by the processors 501 to cause the computer system 500 to operate, such as is described herein below with respect to the various Figures. Examples of computer program product and the execution of such instruction is discussed herein in more detail. The communications adapter 507 interconnects the system bus 502 with a network 512, which can be an outside network, enabling the computer system 500 to communicate with other such systems. In one embodiment, a portion of the system memory 503 and the mass storage 510 collectively store an operating system, which can be any appropriate operating system to coordinate the functions of the various components shown in FIG. 5.

Additional input/output devices are shown as connected to the system bus 502 via a display adapter 515 and an interface adapter 516. In one embodiment, the adapters 506, 507, 515, and 516 can be connected to one or more I/O buses that are connected to the system bus 502 via an intermediate bus bridge (not shown). A display 519 (e.g., a screen or a display monitor) is connected to the system bus 502 by the display adapter 515, which can include a graphics controller to improve the performance of graphics intensive applications and a video controller. A keyboard 521, a mouse 522, a speaker 523, etc., can be interconnected to the system bus 502 via the interface adapter 516, which can include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 5, the computer system 500 includes processing capability in the form of the processors 501, storage capability including the system memory 503 and the mass storage 510, input means such as the keyboard 521 and the mouse 522, and output capability including the speaker 523 and the display 519.

In some embodiments, the communications adapter 507 can transmit data using any suitable interface or protocol, such as the internet small computer system interface, among others. The network 512 can be a cellular network, a radio network, a wide area network (WAN), a local area network (LAN), or the Internet, among others. An external computing device can connect to the computer system 500 through the network 512. In some examples, an external computing device can be an external webserver or a cloud computing node.

It is to be understood that the block diagram of FIG. 5 is not intended to indicate that the computer system 500 is to include all of the components shown in FIG. 5. Rather, the computer system 500 can include any appropriate fewer or additional components not illustrated in FIG. 5 (e.g., additional memory components, embedded controllers, modules, additional network interfaces, etc.). Further, the embodiments described herein with respect to computer system 500 can be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

FIG. 6 is a block diagram of a computer system 602 for automatic 2D overview drawing or sketch generation using photogrammetry according to one or more embodiments. Elements of computer system 500 may be used in and/or integrated in computer system 602.

Data in database 690 in memory 608 can include a 3D point cloud, also referred to as 3D point cloud data, point cloud, a 3D image, etc. The 3D point cloud includes 3D point cloud data points. Data in database 690 in memory 608 can include 2D images. In an embodiment, the 2D images were acquired while performing photogrammetry at a scene, such as an automobile accident scene or a crime scene for example. In the embodiments described herein, the data in database 690 can be generated by a camera via photogrammetry; however other types of coordinate measurement devices may be used for generating the 3D point cloud data, such as but not limited to a TOF laser scanner a structured light scanner or a triangulation scanner, and/or another suitable three-dimensional coordinate scanning device. In an embodiment, the drone being used for photogrammetry may include an optical scanner 670, such as a TOF laser scanner for example. Software application 604 can be used with, integrated in, call, and/or be called by other software applications, such as machine learning model 606, photogrammetry software 612, drawing software, etc., for processing 3D point cloud data and 2D images as understood by one of ordinary skill in the art.

In one or more embodiments, software application 604 can be employed by a user for processing and manipulating 2D images and 3D point cloud data using a user interface such as, for example, a keyboard, mouse, touch screen, stylus, etc. Software application 604 can include and/or work with a graphical user interface (GUI), and features of the software application 604 can receive the output from the machine learning model 606 to edit, draw, and animate 2D images and/or 3D point cloud data as discussed herein. As understood by one of ordinary skill in the art, software application 604 includes functionality for processing any 2D image and 3D image including a 3D point cloud. In one or more embodiments, the software application 604 can include features of, be representative of, and/or be implemented in FARO® Zone 2D Software, FARO® Zone 3D Software, FARO® PhotoCore Software, and/or FARO® Scene Software, all of which are provided by FARO® Technologies, Inc. Software application 604 can call and/or include the features and functionality of photogrammetry software 612. Photogrammetry is a technique to obtain reliable data of real-world objects in the environment by creating 3D models from photos. 2D and 3D data is extracted from an image and, with overlapping photos of an object, building, scene, or terrain, converted into a digital 3D model.

Photogrammetry is a technique for modeling objects using images, such as photographic images acquired by a digital camera for example. Photogrammetry can make 3D models from 2D images or photographs. When two or more images are acquired at different positions that have an overlapping field of view, common points or features may be identified on each image. By projecting a ray from the camera location to the feature/point on the object, the 3D coordinate of the feature/point may be determined using trigonometry or triangulation. In some examples, photogrammetry may be based on markers/targets (e.g., lights or reflective stickers) or based on natural features. To perform photogrammetry, for example, images are captured, such as with a camera (e.g., the camera 680) having a sensor, such as a photosensitive array for example. By acquiring multiple images of an object, or a portion of the object, from different positions or orientations, 3D coordinates of points on the object may be determined based on common features or points and information on the position and orientation of the camera when each image was acquired. In order to obtain the desired information for determining 3D coordinates, the features are identified in two or more images. Since the images are acquired from different positions or orientations, the common features are located in overlapping areas of the field of view of the images. It should be appreciated that photogrammetry techniques are described in commonly-owned U.S. Pat. No. 10,597,753, the contents of which are incorporated by reference herein. With photogrammetry, two or more images are captured and used to determine 3D coordinates of features.

The various components, modules, engines, etc. described regarding the computer system 602 can be implemented as instructions stored on a computer-readable storage medium, as hardware modules, as special-purpose hardware (e.g., application specific hardware, application specific integrated circuits (ASIC s), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the computer system 602 for executing those instructions. Thus, a system memory (e.g., the memory 608) can store program instructions that when executed by the computer system 602 implement the engines described herein. Other engines can also be utilized to include other features and functionality described in other examples herein.

A network adapter (not shown) provides for the computer system 602 to transmit data to and/or receive data from other sources, such as other processing systems, data repositories, and the like. As an example, the computer system 602 can transmit data to and/or receive data from the camera 680, the scanner 670, and/or a user device 660 directly and/or via a network 670.

The network 670 represents any one or a combination of different types of suitable communications networks such as, for example, cable networks, public networks (e.g., the Internet), private networks, wireless networks, cellular networks, or any other suitable private and/or public networks. Further, the network 670 can have any suitable communication range associated therewith and may include, for example, global networks (e.g., the Internet), metropolitan area networks (MANs), wide area networks (WANs), local area networks (LANs), or personal area networks (PANs). In addition, the network 650 can include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

The camera 680 can be a 2D camera or a 3D camera (RGBD or time-of-flight for example). The camera 680 captures an image (or multiple images), such as of an environment 160. The camera 680 transmits the images to the computer system 602. In one or more embodiments, the camera 680 encrypts the image before transmitting it to the computer system 602. Although not shown, the camera 680 can include components such as a processing device, a memory, a network adapter, and the like, which may be functionally similar to those included in the computer system 500, 602 as described herein.

In some examples, the camera 680 is mounted to a mobile base, which can be moved about the environment 160. In some examples, the camera 680 is disposed in or mounted to an unmanned aerial vehicle. In various examples, the camera 680 is mounted on a manned aerial vehicle and/or unmanned aerial vehicle, generally referred to as a drone. In some examples, the camera 680 is mounted to a fixture, which is user-configurable to rotate about a roll axis, a pan axis, and a tilt axis. In such examples, the camera 680 is mounted to the fixture to rotate about the roll axis, the pan axis, and the tilt axis. Other configurations of mounting options for the camera 680 also are possible.

A coordinate measurement device, such as scanner 670 for example, is any suitable device for measuring 3D coordinates or points in an environment, such as the environment 160, to generate data about the environment. The scanner 670 may be implemented as a TOF laser scanner 20. A collection of 3D coordinate points is sometimes referred to as a point cloud. According to one or more embodiments described herein, the scanner 670 is a three-dimensional (3D) laser scanner time-of-flight (TOF) coordinate measurement device. It should be appreciated that while embodiments herein may refer to a laser scanner, this is for example purposes and the claims should not be so limited. In other embodiments, other types of coordinate measurement devices or combinations of coordinate measurement devices may be used, such as but not limited to triangulation scanners, structured light scanners, laser line probes, photogrammetry devices, and the like. A 3D TOF laser scanner steers a beam of light to a non-cooperative target such as a diffusely scattering surface of an object. A distance meter in the scanner 670 measures a distance to the object, and angular encoders measure the angles of rotation of two axles in the device. The measured distance and two angles enable a processor in the scanner 670 to determine the 3D coordinates of the target.

A TOF laser scanner, such as the scanner 670, is a scanner in which the distance to a target point is determined based on the speed of light in air between the scanner and a target point. Laser scanners are typically used for scanning closed or open spaces such as interior areas of buildings, industrial installations, and tunnels. They may be used, for example, in industrial applications and accident reconstruction applications. A laser scanner, such as the scanner 670, optically scans and measures objects in a volume around the scanner 670 through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected and stored as a point cloud, which can be transmitted to the computer system 602 and stored in the database 690 about the environment 160.

In some examples, the scanner 670 is mounted to a mobile base, which can be moved about the environment 160. In some examples, the scanner 670 is disposed in or mounted to an unmanned aerial vehicle. In various examples, the scanner 670 is mounted on a manned aerial vehicle and/or unmanned aerial vehicle, generally referred to as a drone. In some examples, the scanner 670 is mounted to a fixture, which is user-configurable to rotate about a roll axis, a pan axis, and a tilt axis. In such examples, the scanner 670 is mounted to the fixture to rotate about the roll axis, the pan axis, and the tilt axis. Other configurations of mounting options for the scanner 670 also are possible.

According to one or more embodiments described herein, the camera 680 captures 2D image(s) of the environment 160 and the scanner 670 captures 3D information of the environment 160. In some examples, the camera 680 and the scanner 670 are separate devices; however, in some examples, the camera 680 and the scanner 670 are integrated into a single device. For example, the camera 680 can include depth acquisition functionality and/or can be used in combination with a 3D acquisition depth camera, such as a time of flight camera, a stereo camera, a triangulation scanner, LIDAR, and the like. In some examples, 3D information can be measured/acquired/captured using a projected light pattern and a second camera (or the camera 680) using triangulation techniques for performing depth determinations. In some examples, a time-of-flight (TOF) approach can be used to enable intensity information (2D) and depth information (3D) to be acquired/captured. The camera 680 can be a stereo-camera to facilitate 3D acquisition. In some examples, a 2D image and 3D information (i.e., a 3D data set) can be captured/acquired at the same time; however, the 2D image and the 3D information can be obtained at different times.

The user device 660 (e.g., a smartphone, a laptop or desktop computer, a tablet computer, a wearable computing device, a smart display, and the like) can also be located within or proximate to the environment 160. The user device 660 can display an image of the environment 160, such as on a display of the user device 660 (e.g., the display 519 of the computer system 500 of FIG. 5) along with a digital visual element. In some examples, the user device 660 can include components such as a processor, a memory, an input device (e.g., a touchscreen, a mouse, a microphone, etc.), an output device (e.g., a display, a speaker, etc.), and the like.

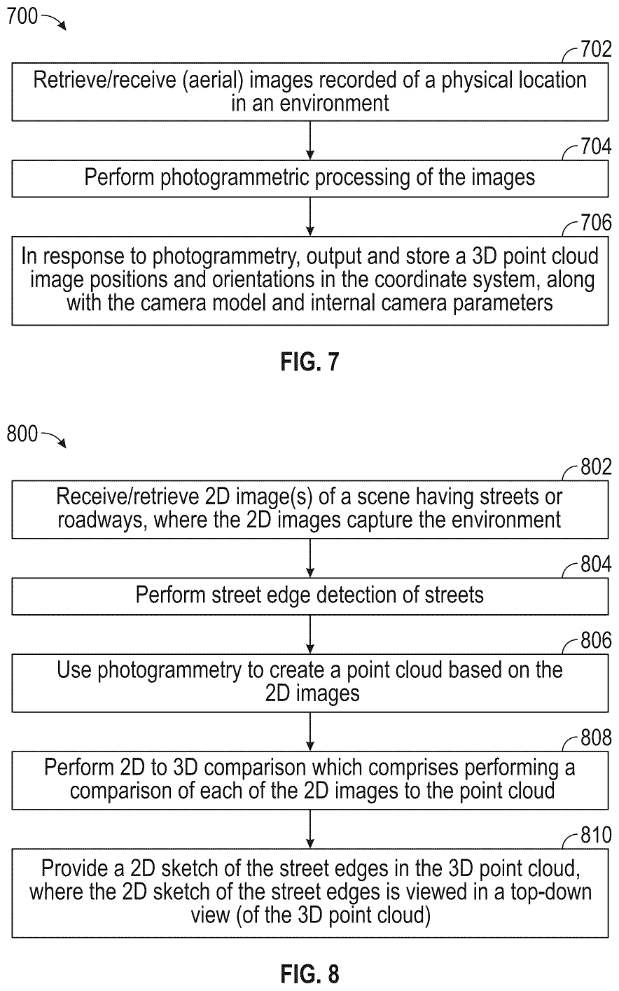

For ease of understanding and not limitation, an example scenario is illustrated that using drones to assist public safety professionals with crash scene reconstruction. It should be appreciated that embodiments are not limited to the example scenario and other environments may be used. FIG. 7 depicts a flowchart 700 for processing images according to one or more embodiments. A drone, such an unmanned or manned aerial vehicle, may include the camera 680 to capture aerial images of a physical location which can be the environment 160. The physical location can be a crash scene. Numerous images (e.g., typically several hundred images) may be captured and stored as data in database 690 in computer system 602.

At block 702, the software application 604 is configured to retrieve and/or receive images 622 of the environment 160 (e.g., crash scene) from the database 690. The images 622 are (2D) aerial images of the environment 160. The images 622 and other 2D images in database 903 may have been converted to orthoimages, orthophotos, or orthoimages. An orthophoto, orthophotograph, orthoimage, or orthoimagery is an aerial photograph or satellite imagery geometrically corrected (“orthorectified”) such that the scale is uniform: the photo or image follows a given map projection. Unlike an uncorrected aerial photograph, an orthophoto can be used to measure true distances, because it is an accurate representation of the earth's surface, having been adjusted for topographic relief, lens distortion, and camera tilt.

Although aerial images captured by drones may be utilized, images are not limited to those captured by drones. Other orthographic photos/images can be used including point cloud scanner data, Google® images, map photos/images, etc. Additionally, the images may be converted into orthoimages, using a suitable technique as understood by one of ordinary skill in the art.

For accuracy and distance validation, various techniques can be used. An agency capturing aerial images can typically use the FARO® scalebar (for NIST traceability). This is an accurate way to verify distance measurement (of the drawing/sketch discussed herein) because it is based on software measurements and not the user. If a scalebar is not present, one can use a known measurement in their scene. Typically, a yard stick can be used or a tape measure at a known length can be used in the scene of the captured image. If a known measurement is not used, the user can utilize fixed points, such as the lane width or a door width of a vehicle. There are many options about how many times to use a measurement for accuracy. Some may use the measure just once in a project. Others may use the measurement for accuracy at the first and last scan, while some may use it for each scan.

Referring to FIG. 7 at block 704, the software application 604 is configured to call, use, and/or communicate with photogrammetry software 612 to perform photogrammetric processing or photogrammetry on the images 622. Photogrammetry is a technique to obtain reliable data of real-world objects in the environment by creating 3D models from photos. Digital image capturing and photogrammetric processing includes several well defined stages, which allow the generation of 2D or 3D digital models of the object as an end product, as obtained by software application 604 at block 706. Photogrammetry may include the following: feature detection in the images, feature matching between images, estimation of position and orientation for each image in 3D space, bundle adjustment to fine tune the position and orientation, and output of a 3D point cloud of the environment 160.

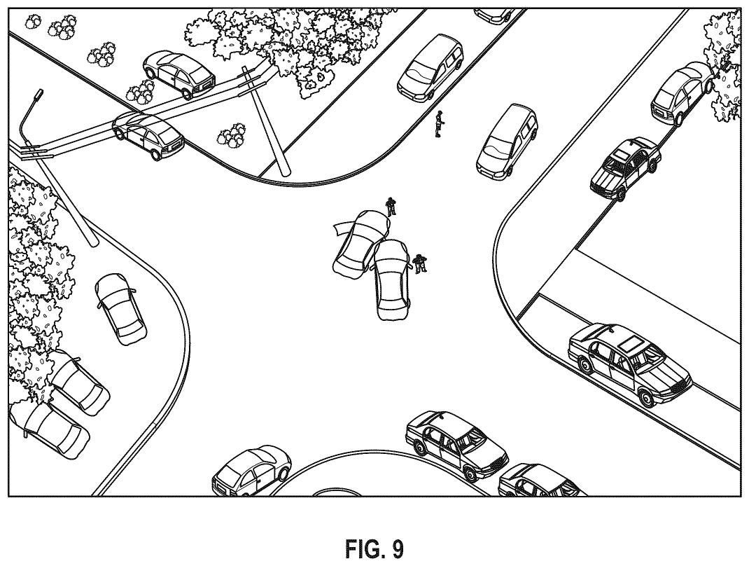

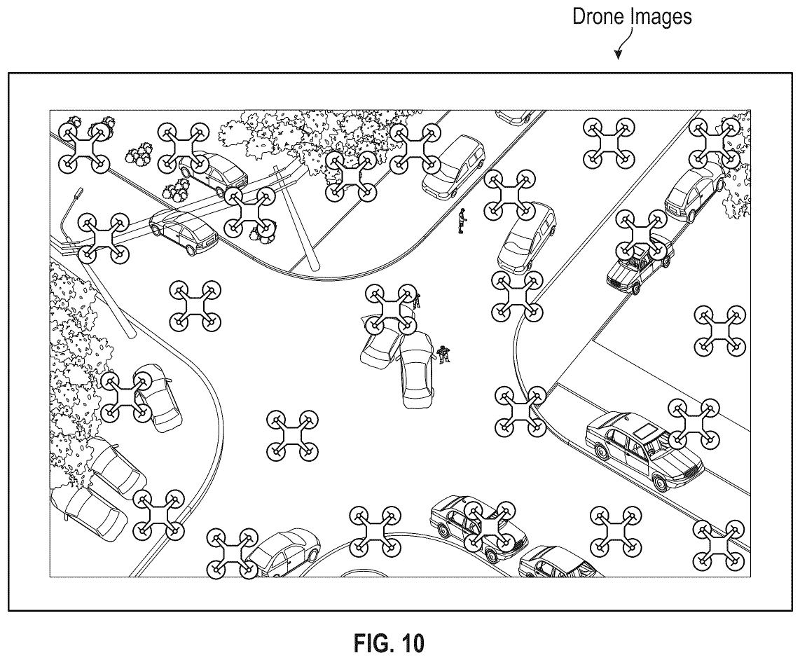

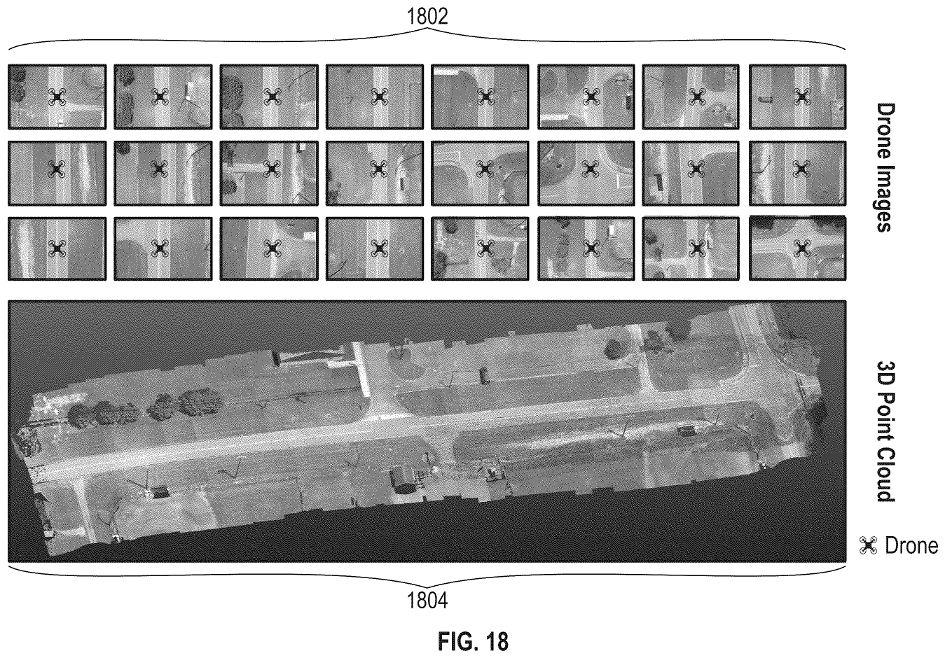

As a result of the feature extraction, feature matching, and bundle adjust during the photogrammetry, the photogrammetry software 612 also returns the image positions and orientations (of the 2D images 622 utilized to create the 3D point cloud 628) in the coordinate system of the calculated 3D point cloud, which can be stored in database 690. This information of the image positions and orientations is relevant for further processing discussed in FIG. 8. As stored in database 690, the photogrammetry software 612 also returns the camera model and the internal camera parameters which can be utilized to refine the results for further processing discussed in FIG. 8. FIG. 9 depicts a combination of (2D) aerial images of an example environment according to one or more embodiments. In this example, aerial images may be combined using photogrammetry to result in the 2D image depicted in FIG. 9, as understood by one of ordinary skill in the art. Although a crash scene may be illustrated, other types of aerial images may be utilized. FIG. 10A illustrates example drone poses for capturing the aerial images according to one or more embodiments. Photogrammetry may be utilized to create a 3D point cloud from the aerial images at different poses in FIG. 10. For example, FIG. 18 illustrates an example of multiple drone images 1802 where photogrammetry is utilized to generate a 3D point cloud 1804 of the drone images 1802.

FIG. 8 depicts a flowchart of a computer-implemented method 800 for generating a drawing/sketch of street edges in 2D image(s) and generating the sketch in a 3D image according to one or more embodiments described herein. The computer-implemented method 800 can be performed by or implemented on any suitable processing system, for example, the computer system 602 in FIG. 6, a cloud computing node, and/or combinations thereof.

At block 802 of the computer-implemented method 800, the software application 604 is configured to perform image selection to receive/retrieve one or more 2D images 622 representing the environment 160 having been captured by the camera 680. The environment 160, for example, is the physical location of the crash scene having streets or roadways, where the 2D images 622 capture the environment. All (drone) images may be utilized for the photogrammetric process discussed in FIG. 7 or another process for photogrammetry. However, the software application 604 is configured to utilize a subset of images in database 690 to find 2D structures or regions of interest in the 3D point cloud. The software application 604 may be configured to select certain ones of the images 622 based on some of the photogrammetry statistics, such as (only) select images that do not share many common features (e.g., less than a predetermined number of common features), which is utilized to reduce the redundancy of selected images. In cases where some redundancy is desired, the software application 604 can be configured to select certain ones of the images 622 based on having line segments and/or street marking seen in several images for improved accuracy or robustness.

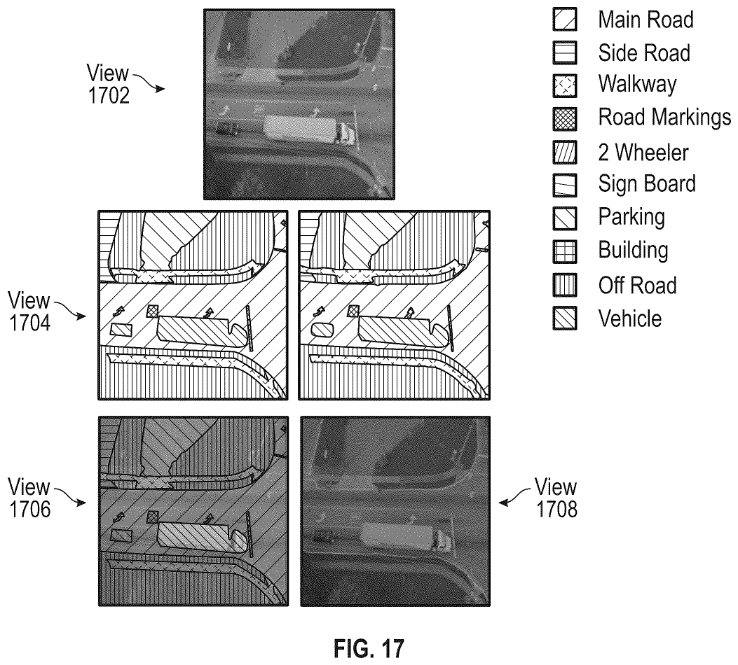

At block 804, the software application 604 employs the machine learning model 606 to detect and segment objects/areas including surface regions/areas, for example, streets and/or roadways, in the selected (2D) images 622. Surface regions are streets and roadways, and the streets and roadways have edges delineating the surface region from another region such as the grass, curb, etc. In one or more embodiments, the machine learning mode 606 can identify (output) which parts of the image 622 depict a street, a parking lot, a building, a vehicle, walkway, road/street markings, sign boards, etc., as illustrated in FIG. 17. In one or more embodiments, the software application 604 may have rules-based instructions to determine the street edges of streets and/or roadways, which were identified/segmented as objects in the images 622. In one or more embodiments, the software application 604 is configured to input the selected images 622 to the machine learning model 606 for processing to determine the street edges. It is noted that street markings and lane lines are for separating traffic traveling the opposite and/or same directions.

The machine learning model 606 is trained to identify structures in the images 622 as segments (or objects) which represent the street edges of the street and also identify street markings on the street. The machine learning model 606 is configured to generate an output data 626 as 2D coordinates (e.g., x, y coordinates) of the segments (or segmented objects) of the street edges and street markings in the image(s) 622. The segments can also be vehicles, parking lots, building, etc. The software application 604 is configured to store the output data 626.

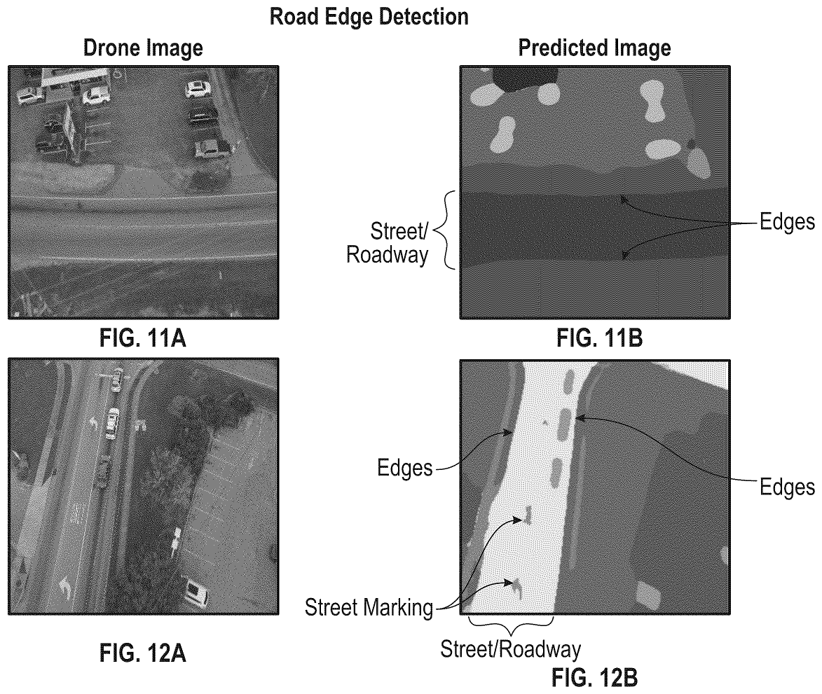

FIGS. 11A and 12A depict drone images as example aerial images. After processing by the machine learning model 606, FIG. 11B illustrates a monochromatic predicted image of the drone image in FIG. 11A, where FIG. 11B shows that the image has been segmented. After processing by the machine learning model 606, FIG. 12B illustrates a predicted image of the drone image in FIG. 12A, where FIG. 12B shows that the image has been segmented. In FIGS. 11B and 12B, the street or roadway (i.e., surface region) has been segmented along with street marking and other objects. Coordinates (x, y coordinates) of the street edges are captured and included in the output data 626 because each segmented object has coordinates. Also, the coordinates of traffic lines, markings, and points of interest may also be captured and saved in the output data 626. Moreover, the output data 626 of the machine learning model 606 is a mask which identifies (i.e., segments) all objects from the present in the images, and machine learning model 606 may apply a unique color coding, pattern, shading, etc., to each segmented object as depicted in FIG. 17. The mask indicates where each object is and what objects are present in the 2D image 622. Streets are object which the trained machine learning model 606 (neural network) detects; the street edges may be determined/inferred using computer vision techniques or and/or rules-based algorithms.

Optionally, as segmentation improvements, the software application 604 may compare the street edges in the output data 626 to streets in the selected images 622. In cases where there happen to be broken lines of the street edges, the software application 604 can fill or connect the broken lines of the street edges accordingly. For example, the software application 604 can identify a train of broken lines for street edges in the output data 626 and find the corresponding locations (x, y coordinates) in the selected images 622, and then extrapolate to find the missing line pieces (and/or coordinates). The software application 604 is configured to include any additional x, y coordinates found during the segmentation improvement in the output data 626.

In one or more embodiments, the machine learning model 606 can include various engines/classifiers and/or can be implemented on a neural network. The features of the engines/classifiers can be implemented by configuring and arranging the computer system 602 to execute machine learning algorithms. In general, machine learning algorithms, in effect, extract features from received data (e.g., inputs of 2D images) in order to “classify” the received data. Examples of suitable classifiers include but are not limited to neural networks, support vector machines (SVMs), logistic regression, decision trees, hidden Markov Models (HMMs), etc. The end result of the classifier's operations, i.e., the “classification,” is to predict a class for the data. The machine learning algorithms apply machine learning techniques to the received data in order to, over time, create/train/update a unique “model.” The learning or training performed by the engines/classifiers can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, anomaly detection, neural networks, deep learning, and the like.

In one or more embodiments the engines/classifiers are implemented as neural networks (or artificial neural networks), which use a connection (synapse) between a pre-neuron and a post-neuron, thus representing the connection weight.

Neuromorphic systems are interconnected elements that act as simulated “neurons” and exchange “messages” between each other. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. After being weighted and transformed by a function (i.e., transfer function) determined by the network's designer, the activations of these input neurons are then passed to other downstream neurons, which are often referred to as “hidden” neurons. This process is repeated until an output neuron is activated. Thus, the activated output neuron determines (or “learns”) and provides an output or inference regarding the input.

Neural networks are usually created with base networks and based on requirements. Example base networks utilized include RESNET50, RESNET 10, Xception. It should be appreciated that other base network could be utilized for images. After the creation of the neural network, the dataset (training and testing) is fed to the model with the specific loss function and the training is started. Training consists of different hyperparameters that need to be set in order to achieve better accuracy. The dataset that is fed into the deep learning model is processed, and this called data preparation and augmentation. For illustration and not limitation, the training datasets include aerial (2D) images of streets, roadways, and crash scenes. In some cases, pretrained or partially trained neural networks were used which were further trained using the training datasets. Supervised learning was utilized in which the 2D images were manually segmented and fed to the neural network.

The raw dataset is collected and sorted manually. The sorted dataset is labeled (e.g., using the Amazon Web Services® (AWS®) labeling tool such as Amazon SageMaker® Ground Truth). The labeling tool creates segmentation masks. Although additional labels can be used, a few examples of the labeling used in training the machine learning model 606 included the main road, the side road, walkway, road marking, etc. Both the images and masks are sorted again in order to achieve data balancing and divided into training, testing, and validation datasets. Training and validation are used for training and evaluation, while testing is used after training to test the machine learning model on an unseen dataset. The training dataset may be processed through different data augmentation techniques. Training takes the labeled datasets, base networks, loss functions, and hyperparameters. Once these are all created and compiled, the training of the neural network occurs to eventually result in the trained machine learning model. Once the model is trained, the model (including the adjusted weights) is saved to a file for deployment and/or further testing on the test dataset.

Returning to FIG. 8, at block 806, the software application 604 is configured to perform photogrammetry and/or employ the photogrammetry software 612 to perform photogrammetry on the aerial images for the environment 160 (e.g., crash scene) in database 690, resulting in a 3D point cloud 628. Photogrammetry can be performed as discussed in FIG. 7 and/or any suitable photogrammetric process may be performed. In one or more embodiments, photogrammetry may have been previously performed.

At block 808, the software application 604 is configured to perform a 2D to 3D comparison which comprises comparing the selected 2D images (e.g., in database 690) of the environment 160 to the 3D point cloud 628 of the environment. The reason for this process is to transfer the 2D segmentation information to 3D space. The result of this comparison is a 3D representation of an edge (or multiple edges). At block 810, this 3D edge can be projected again to 2D but with a defined orthogonal view and defined scale. This results in the 2D sketch of the street edges. Corresponding structures in the 2D images can be found and matched to corresponding structures in the 3D point cloud. The image positions and orientations of the 2D images 622, utilized to create the 3D point cloud 628 in the coordinate system, can be utilized for comparing the selected 2D images 622 that had street edges and marking detected to the 3D point cloud 628, and subsequently matching common features (and their coordinates) between the selected 2D images 622 and the 3D point cloud 628. Moreover, the coordinates (x, y coordinates) of the 2D images (particularly the selected 2D images) can be matched and integrated to the corresponding coordinates (x, y, z) in the 3D point cloud 628, and vice versa. To integrate the selected 2D images (having street edges and other marking detected) in the 3D point cloud, various techniques can be utilized including forward projection, back projection, and back projection with segmented images to point cloud.

Forward projection includes finding matching line segments (or features) in multiple 2D images and then triangulating the line segments into the 3D point cloud. This method may be performed for features that can be described in a parametric way. Forward projection (with segmented images to point cloud) may further include projecting the road segments/edges of the drone (2D) images into the 3D point cloud and connecting all the edges to create a curve (straight line/arcs).

Back projection includes projecting 3D data from the photogrammetry 3D point cloud into the 2D images and attributing 3D points to identified lines or segments in the 2D images. This includes ambiguity free back projection strategies. Ambiguities (per 2D image) can arise when there are multiple 3D points (with different distances to the camera) projected into a single pixel. In an example case, this can be resolved by selecting the 3D point with the correct distance, which is typically the closest distance to the camera as only this object would be visible.

At block 810 (which may be in combination with block 808), the software application 604 is configured to draw and insert a 2D sketch/drawing of the output data 626 as street edges (and street markings) in the 3D point cloud 628, where the 2D sketch/drawings of the street edges is formed by drawing lines connecting the coordinates (x, y coordinates) of street edges drawing lines connecting other street markings in the 3D point cloud 628. In some examples, in addition to using the coordinates saved in the output data 626, the drawing/sketch of the lines occurs by at least partially following the segmentations that have segmented in, for example, the predicted images 11B and 12B, resulting in the example drawing/sketch depicted in FIG. 15. Each segmented area, which is a segmented object, has a value and implicitly incorporates the edge. The drawing/sketch is around/on the edges of the segmented object using the values (x, y coordinates) around the segmented object.

For example, the software application 604 is configured to identify the lines/edges as borders between semantic segments (as seen in FIG. 11B or 12B). In 2D images, the lines are therefore a collection of pixel coordinates (x, y coordinates). After the 2D to 3D conversion, the coordinates of the lines/edges are a collection of 3D coordinates (x, y, z coordinates) in object space. In both the 2D image and 3D images, the software application 604 is configured to describe the edges (especially the street edges) by geometric primitives. This means, the software application 604 (using one or more algorithms) works to piecewise fit a line, an arc, a spline, or something similar to the points (2D points or 3D points) describing the edge. This result in a smooth single-pixel width description (in the 2D image) and/or single-3D-point width description (in the 3D image) of the identified edge. This type of filtering can be done in the initial images, in the 3D point cloud, or in the final projection of the 3D edge into a top down view 2D image (discussed further below). The later option would be the optimal choice.

It should be appreciated that the software application 604 is configured to transform the 3D point cloud into a top-down view as a 2D representation of the 3D point cloud. The 2D representation 630 is a 2D image of the 3D point cloud. The software application 604 can determine that the selected 2D images 622 correspond to region(s) of interest in the 3D point cloud, or vice versa. In one or more embodiments, a user may identify a region of interest in the 2D images and/or in the 3D point cloud. In the example scenario, the region of interest could be a crash scene, an intersection at which the crash occurred, etc. The software application 604 is configured to collapse 3D points/coordinates (e.g., x, y, z coordinates) of the 3D point cloud along a defined axis (e.g., z axis which can be height, elevation, etc.) to generate the 2D representation 630. For example, from a top-down view into the 3D point cloud, the coordinates of the z-axis can be reduced to zero (0). There can be filtering performed prior to or after the 2D generation of the 2D representation 630 of the 3D point cloud.

In transforming the 3D point cloud into the top-down 2D representation 630, the 3D structures in the 3D point cloud 628 can be smoothened. Each transferred 3D structure may contain noise like double structures, and a suitable averaging could be used in 3D point could or directly in the final top-view 2D representation 630. Smoothing and refinement can be done by means of redundancy. For example, line A is projected into image 1 and image 2 (or even more images). When different 3D points are to be back projected into the lines in the different images, a mean line can be calculated. Each projected 3D point into a 2D image can be attributed with an error value which may be based on the 2D distance of the projected point to the nearest line segment. Points are searched which produce a global minimum error, for example, a point is taken as a line point in 3D when the square sum of errors is below a fixed threshold and has a minimum value in its 3D neighborhood. Not only real 3D points may be taken this way, but also interpolated points can be found. To get the 3D point in the 2D image, the software application 604 can use a dynamic threshold (for distance between pixel and line segment) and/or fixed dynamic threshold to ensure that the 3D point lies on the edge segment (e.g., street line) in the 2D image.

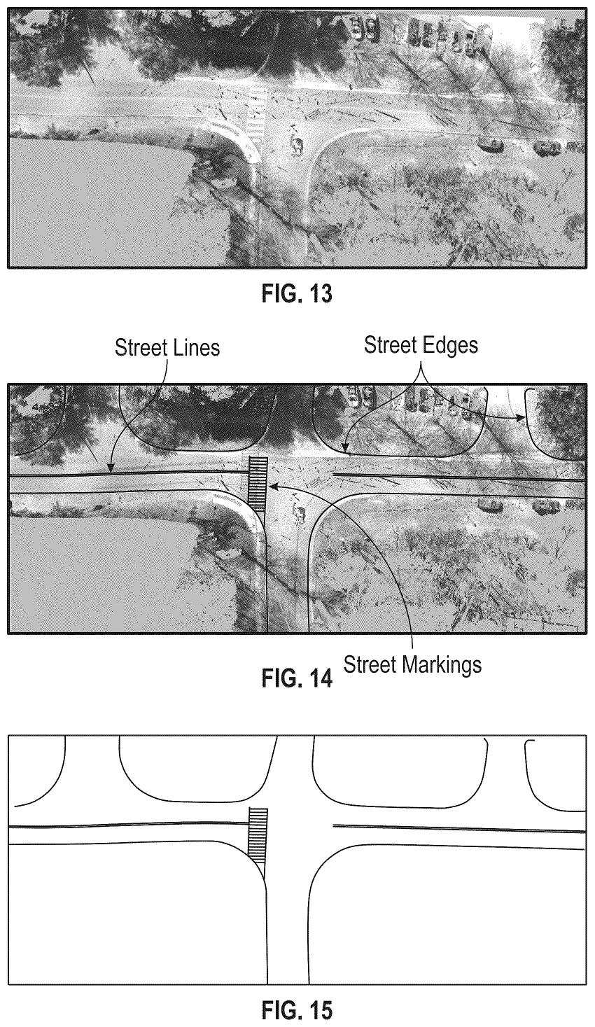

For illustrations purposes and not limitation, FIG. 13 illustrates an example 2D representation 630 of the 3D point cloud 628 without the drawing/sketch of the street edges and street markings. FIG. 14 illustrates the graphical display of example 2D representation 630 of the 3D point cloud 628 with the 2D drawing/sketch of street edges and street markings according to one or more embodiments. The 2D representation 630 of the 3D point cloud 628 with the drawing/sketch can be displayed in a graphical user interface of the software application 604. As discussed herein, the software application 604 is configured to generate/draw/sketch street edges (and other street marking) for the streets and roadways in the selected (2D) images 622, using the output data 626 including image positions and orientations of the large number of images 622 utilized during photogrammetry. In one or more embodiments, the software application 604 may include, call, and/or employ features of a drawing software tool.

FIG. 15 illustrates the display of the drawing/sketch of street edges and street markings without the 2D representation 630 of the 3D point cloud 628 according to one or more embodiments. As discussed herein, the software application 604, for example, using and/or employing a drawing software tool, is configured to automatically draw lines, arcs, etc., to connect the coordinates (x, y coordinates) of the output data 626 in order to draw/sketch the street edges and street markings of streets and roadways.

FIG. 17 illustrates visual display of the automatic 2D sketch generation according to one or more embodiments. Particularly, FIG. 17 illustrates display of an example drone image in view 1702, example segmented images in view 1704, and an example overlay of a segmented image on its corresponding drone image in view 1706. In view 1706, a drawing/sketch of the street edges on the street/roadway has been generated according to one or more embodiments.

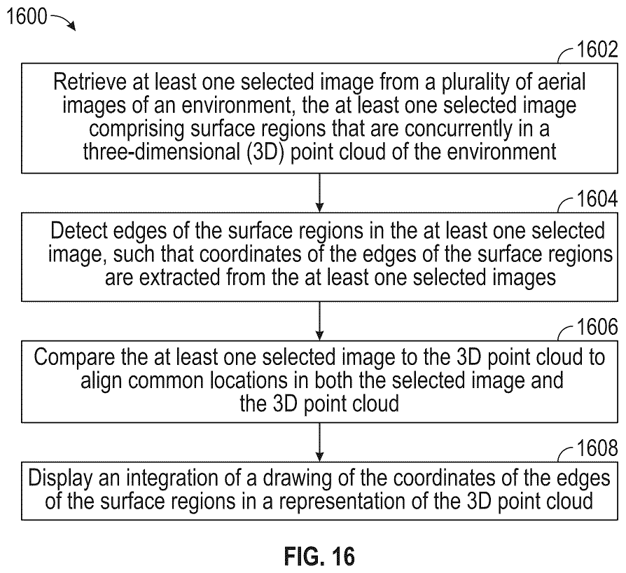

FIG. 16 is a flowchart of a computer-implemented method 1600 for generating street edges in 2D maps using photogrammetry according to one or more embodiments. The software application 604, in conjunction with the photogrammetry software 612, the machine learning model 606 (e.g., a neural network), and software drawing tools, executes the method 1600. The software application 604 includes a graphical user interface (GUI) for displaying the images and the sketch/drawing on a display, such as the display 519 or any other suitable display screen.

At block 1602, the software application 604 is configured to retrieve at least one selected image from a plurality of aerial images (e.g., 2D images in database 690) of an environment (e.g., environment 160), the at least one selected image comprising surface regions that are concurrently in a three-dimensional (3D) point cloud (e.g., 3D point cloud 628) of the environment. In some cases, multiple 2D images may be combined using photogrammetry into a larger view of a 2D image. In some cases, multiple 2D images can be selected for processing.

At block 1604, the software application 604 is configured to detect areas/objects (having edges) of the surface regions in the at least one selected image, such that coordinates of the edges of the surface regions are extracted from the at least one selected images. The software application 604 can call on and/or use the machine learning model 606 (having machine learning algorithms) for area/object detection, which results in output data 626. The output data 626 includes segmented images, identified street lines (i.e., street edges), road marking, etc., as well as their coordinates (x, y coordinates).

At block 1606, the software application 604 is configured to (respectively) compare the at least one selected image(s) to the 3D point cloud 628 to align common locations/features in both the selected image and the 3D point cloud. The comparison can use forward projection, back projection, etc.

At block 1608, the software application 604 is configured to display (e.g., on display 519) an integration of a drawing/sketch of the coordinates (e.g., 2D coordinates such as x, y coordinates) of the edges of the surface regions in a representation (e.g., 2D representation 630) of the 3D point cloud 628. An example of the drawing/sketch is depicted in FIG. 15. The integration of the drawing/sketch in the 2D representation 630 is illustrated in FIG. 14, with street edges, street lines, and street markings. An example of the 2D representation without the drawing/sketch is illustrated in FIG. 13.

The 3D point cloud 628 is generated from the plurality of aerial images using photogrammetry. The at least one selected image(s) (e.g., images 622) is selected from the plurality of aerial images (e.g., database 690) having been used to generate the 3D point cloud 628, for example, using photogrammetry. The edges of the surface regions (e.g., streets, roadways, etc.) are detected using machine learning (e.g., trained machine learning model 606). Street lines and road markings can also be identified.

The plurality of aerial images are orthoimages. The coordinates of the edges of the surface regions are connected by lines to form the drawing of the edges, for example, as depicted in FIGS. 14 and 15. Forward projection is utilized to integrate the drawing into the 3D point cloud 628. Back projection is utilized to match 2D information from the at least one selected images to 3D data of the 3D point, and smoothing the identified line in 3D by finding 3D points for a line in which the 3D points have a minimal squared sum of a back projection error into a plurality of images. For example, during back projection, the software application 604 is configured to identify segments, edges, or similar structures in the 2D images and transfer this knowledge to the 3D data. 3D points of the 3D point cloud are back projected into a plurality of images. It may be noted that a selection of 3D points can be used which was identified as candidate 3D points belonging to the line or being close to the line. For each of these points an error is computed for each image which depends on the distance of the back projected 2D point to the 2D line identified in this image. As an example, this error can be calculated as the pixel distance between the back projected point and the line in 2D. Now, the candidate 3D points can be filtered in an optional step by applying a threshold which removes points above a defined distance from the list of candidate points. Due to noise and sampling related artefacts, it is not expected that a 3D point is being back projected into multiple images and having a minimum error calculated for each image. To identify a global optimal point, we identify these candidate points which have a minimum global error in a plurality of images. This global error can be defined as the squared sum of the individual errors calculated per image, but also more advanced error combinations can be used e.g. which neglect single large errors when they are calculated as a median value of the individual errors. This results in a smoothed line which is expected to be less impacted by noise or individual image artefacts. Additionally, new 3D points which are not part of the list of candidate 3D points can be found by interpolating between two or more existing 3D points and this additional 3D point has a smaller global reprojection error than the 3D data of the original 3D point cloud. This can result in an even smoother line in 3D. The drawing of the coordinates of the edges of the surface regions is displayed (e.g., on display 519) in an orthographic view of the 3D point cloud 628, for example, as depicted in FIG. 14.

While embodiments of the invention have been described in detail in connection with only a limited number of embodiments, it should be readily understood that embodiments of the invention are not limited to such disclosed embodiments. Rather, embodiments of the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, embodiments of the invention are not to be seen as limited by the foregoing description, but is only limited by the scope of the appended claims.

What is claimed is:

1. A computer-implemented method comprising:
retrieving at least one selected image from a plurality of aerial images of an environment, the at least one selected image comprising surface regions that are concurrently in a three-dimensional (3D) point cloud of the environment;
detecting areas of the surface regions in the at least one selected image, such that coordinates of the areas of the surface regions are extracted from the at least one selected image;
comparing the at least one selected image to the 3D point cloud to align common locations in both the at least one selected image and the 3D point cloud; and
displaying an integration of a drawing of the coordinates of the areas of the surface regions in a representation of the 3D point cloud.

2. The computer-implemented method of claim 1, wherein the 3D point cloud is generated from the plurality of aerial images using photogrammetry.

3. The computer-implemented method of claim 1, wherein the at least one selected image is selected from the plurality of aerial images having been used to generate the 3D point cloud.

4. The computer-implemented method of claim 1, wherein the areas of the surface regions are detected using machine learning.

5. The computer-implemented method of claim 1, wherein the plurality of aerial images are orthoimages.

6. The computer-implemented method of claim 1, wherein the coordinates of the areas of the surface regions are connected by lines to form the drawing of the areas, the lines being formed along edges of the surface regions.

7. The computer-implemented method of claim 1, wherein forward projection is utilized to integrate the drawing into the 3D point cloud.

8. The computer-implemented method of claim 1, wherein:
back projection is utilized to integrate 3D data of the 3D point cloud into the at least one selected image; and
smoothing the 3D representation of a line by finding 3D points for a line in which the 3D points have a minimal squared sum of a back projection error into a plurality of images.

9. The computer-implemented method of claim 1, wherein the drawing of the coordinates of the areas of the surface regions is displayed in an orthographic view of the 3D point cloud.

10. A system comprising:
a memory having computer readable instructions; and
one or more processors for executing the computer readable instructions, the computer readable instructions controlling the one or more processors to perform operations comprising:
retrieving at least one selected image from a plurality of aerial images of an environment, the at least one selected image comprising surface regions that are concurrently in a three-dimensional (3D) point cloud of the environment;
detecting areas of the surface regions in the at least one selected image, such that coordinates of the areas of the surface regions are extracted from the at least one selected image;
comparing the at least one selected image to the 3D point cloud to align common locations in both the at least one selected image and the 3D point cloud; and
displaying an integration of a drawing of the coordinates of the areas of the surface regions in a representation of the 3D point cloud.

11. The system of claim 10, wherein the 3D point cloud is generated from the plurality of aerial images using photogrammetry.

12. The system of claim 10, wherein the at least one selected image is selected from the plurality of aerial images having been used to generate the 3D point cloud.

13. The system of claim 10, wherein the areas of the surface regions are detected using machine learning.

14. The system of claim 10, wherein the plurality of aerial images are orthoimages.

15. The system of claim 10, wherein the coordinates of the areas of the surface regions are connected by lines to form the drawing of the areas, the lines being formed along edges of the surface regions.

16. The system of claim 10, wherein forward projection is utilized to integrate the drawing into the 3D point cloud.

17. The system of claim 10, wherein back projection is utilized to integrate 3D data of the 3D point cloud into the at least one selected image; and
smoothing the at least one selected image by finding 3D points for a line in which the 3D points have a minimal squared sum of a back projection error into a plurality of images.

18. The system of claim 10, wherein the drawing of the coordinates of the areas of the surface regions is displayed in an orthographic view of the 3D point cloud.

19. A method comprising:
retrieving at least one selected image from a plurality of aerial images of an environment, the at least one selected image comprising surface regions;
detecting areas of the surface regions in the at least one selected image, such that coordinates of the areas of the surface regions are extracted from the at least one selected image;
comparing the at least one selected image to a 3D point cloud to align common locations in both the at least one selected image and the 3D point cloud; and
displaying an integration of a drawing of the coordinates of the areas of the surface regions in a representation of the 3D point cloud.

20. The computer program product of claim 19, wherein the 3D point cloud is generated from the plurality of aerial images using photogrammetry.
